(19) United States
(12) Patent Application Publication
(10) Pub. No.: US 2014/0265440 A1
(43) Pub. Date: Sep. 18, 2014

(54) CART HAVING CORNER BUMPERS, SIDE CONTAINERS, AND CORNER TOP HOLDERS

(71) Applicants: KUNG-CHENG CHEN, Taichung City (TW); LUNG-CHUAN HUANG, Taichung City (TW)

(72) Inventors: KUNG-CHENG CHEN, Taichung City (TW); LUNG-CHUAN HUANG, Taichung City (TW)

(21) Appl. No.: 13/826,212

(22) Filed: Mar. 14, 2013

(51) Int. Cl. B62B 5/00

(52) U.S. Cl. CPC B62B 5/0006
USPC 296/186.1

(57) ABSTRACT

A cart includes a support body; and two side frames being rectangular wherein each side frame includes two spaced vertical bumpers and two spaced horizontal cross rails, each bumper has a cross section of about rectangle, each bumper includes a top hole and a plurality of spaced side holes along one surface facing an other bumper of the same side frame, each cross rail has a cross section of rectangle, and each cross rail includes a plurality of threaded holes so as to threadedly secure the side frames to both sides of the support body respectively. The cart further includes at least one side container and at least one corner top holder.

### BACKGROUND OF THE INVENTION

1. Field of the Invention

The invention relates to carts having drawers and more particularly to a cart having drawers, four corner bumpers, two side containers, and two corner top holders.

2. Description of Related Art

Conventionally, a cart having drawers for storing tools is provided with a flat top. It is often that additional containers or shelves are releasably attached to sides for storing items. However, such arrangements are not aesthetic.

In a warehouse, there are many carts having drawers for storing items. It is often that the carts collide due to close proximity. The collision can damage the carts and even hurt employees.

Thus, the need for improvement still exists.

### SUMMARY OF THE INVENTION

It is therefore one object of the invention to provide a cart comprising a support body; and two side frames being rectangular wherein each of the side frames includes two spaced vertical bumpers and two spaced horizontal cross rails, each of the bumpers has a cross section of about rectangle, each of the bumpers includes a top hole and a plurality of spaced side holes along one surface facing an other bumper of the same side frame, each of the cross rails has a cross section of rectangle, and each of the cross rails includes a plurality of threaded holes so as to threadedly secure the side frames to both sides of the support body respectively.

The above and other objects, features and advantages of the invention will become apparent from the following detailed description taken with the accompanying drawings.

### BRIEF DESCRIPTION OF THE DRAWINGS

FIG. 1 is a perspective view of a cart having drawers, corner bumpers, side containers, and corner top holders according to the invention;

FIG. 2 is an exploded perspective view of the cart and one side frame;

FIG. 3 is a perspective view of the side frame of FIG. 2;

FIG. 4 is an exploded view of one side frame, two side containers, and a pivotal holder on top of one corner bumper of one side frame; and

FIG. 5 is an exploded view of an other side frame, an other pivotal holder on top of one corner bumper of the other side frame, and a handle.

### DETAILED DESCRIPTION OF THE INVENTION

Referring to FIGS. 1 to 5, a parallelepiped cart including a plurality of drawers (not numbered), a support body 20, two side frames 10 on both sides of the support body 20 respectively, two pivotal arms 30, two rectangular holders 31, a handle 32, and two side containers 33 according to the invention is shown.

As shown in FIGS. 1 to 3, the side frame 10 is rectangular and comprises two spaced vertical bumpers 11 formed of elastomeric material and two spaced horizontal cross rails 12. The side frames 10 are threadedly secured to both sides of the support body 20 respectively. The bumper 11 has a cross section of about rectangle and one of its four corners is curved. The bumper 11 comprises a top hole 111 and a plurality of spaced holes 112 along one surface facing the other bumper 11 of the same side frame 10. The cross rail 12 has a cross section of rectangle and comprises a flange 121 along one edge for increasing the structural strength and a plurality of threaded holes 122 so that a plurality of fasteners can be driven through the threaded holes 122 into the wall of the support body 20 to secure the side frame 10 to the support body 20.

As shown in FIGS. 4 and 5, the arm 30 has one end pivotably disposed in the top hole 111 so that the arm 30 may pivot about the bumper 11. The holder 31 is disposed on an other end (i.e., top) of the arm 30. An item can placed on the holder 31 in work. The handle 32 is threadedly secured to upper portions of the bumpers 11 of the same side frame 10 so that an employee may hold the handle 32 to wheel the cart in work. The side container 33 comprises two through holes 331 adjacent to two inner bottom corners respectively. Each of two pins 34 can be disposed through the through hole 331 into the corresponding hole 112 to releasably secure the side container 33 to the bumpers 11 of the same side frame 10. Preferably, the side containers 33 are sufficiently spaced for ease of items access. Further, the side frames 10 and the side containers 33 serve as a cushion for absorbing impact in case of collision of the cart and a foreign object.

While the invention has been described in terms of preferred embodiments, those skilled in the art will recognize that the invention can be practiced with modifications within the spirit and scope of the appended claims.

What is claimed is:

1. A cart comprising:
a support body; and
two side frames being rectangular wherein each of the side frames includes two spaced vertical bumpers and two spaced horizontal cross rails, each of the bumpers has a cross section of about rectangle, each of the bumpers includes a top hole and a plurality of spaced side holes along one surface facing an other bumper of the same side frame, each of the cross rails has a cross section of rectangle, and each of the cross rails includes a plurality of threaded holes so as to threadedly secure the side frames to both sides of the support body respectively.

2. The cart of claim 1, further comprising at least one arm each having one end pivotably disposed in the top hole.

3. The cart of claim 2, further comprising at least one holder each disposed on an other end of the arm.

4. The cart of claim 1, further comprising a handle threadedly secured to upper portions of the bumpers of the side frame.

5. The cart of claim 1, further comprising at least one side container each including two through holes adjacent to two inner corners respectively.

6. The cart of claim 5, further comprising at least one pair of pins wherein the pins of the same pair are disposed through the through holes into the corresponding side holes to releasably secure the side container to the bumpers of the side frame.
